(19) United States
(12) Patent Application Publication
(10) Pub. No.: US 2016/0143034 A1
(43) Pub. Date: May 19, 2016

(54) FREQUENCY RESOURCE ALLOCATION METHOD AND BASE STATION DEVICE

(71) Applicant: NEC CORPORATION, Tokyo (JP)

(72) Inventor: Takashi MOCHIZUKI, Tokyo (JP)

(73) Assignee: NEC CORPORATION, Tokyo (JP)

(21) Appl. No.: 14/898,300

(22) PCT Filed: Jan. 16, 2014
(86) PCT No.: PCT/JP2014/050700

§ 371 Date: Dec. 14, 2015

(30) Foreign Application Priority Data
Jun. 18, 2013 (JP) 2013-127517

(51) Int. Cl. H04W 72/04; H04L 5/00; H04W 72/08

(52) U.S. Cl. CPC H04W 72/0453; H04W 72/08; H04L 5/0007

(57) ABSTRACT

This frequency resource allocation method involves receiving, from each mobile station, channel quality information for each frequency resource and a determination result indicating whether or not data has been correctly received by the whole of the frequency resources allocated to that mobile station; for each mobile station, an allocation index for the allocation of frequency resources is calculated on the basis of the channel quality information and the determination result received from the mobile station, and frequency resources are allocated to each mobile station on the basis of the allocation index. To calculate the allocation index, a correction value based on the determination result is found for each of multiple groups into which the frequency resources allocated to that mobile station are divided, and then the allocation index is calculated on the basis of the correction value for each group and the channel quality information.

### TECHNICAL FIELD

The present invention relates to a frequency resource allocation method by means of an Orthogonal Frequency-Division Multiple Access (OFDMA) system, and a base station device or cell station that carries out a frequency resource allocation.

### BACKGROUND

In an OFDMA system, a frequency resource allocation for executing a multiple-user communication is generally carried out as described below. At first, each mobile station measures power of reference signals transmitted from cell stations, with respect to each frequency resource, and transmits Channel Quality Information (CQI) such as a signal-to-interference-power ratio of each frequency resource, to the cell station to be connected to. At the cell station, frequency resources are allocated in accordance with the Channel Quality Information transmitted from the mobile station under control.

In a multi-cell environment, interference between cells is affected by a frequency resource allocation status at each cell, directions of a transmission beam of a cell station as well as a receiving beam of a mobile station, and the like. Therefore, simply allocating frequency resources by using a reference signal transmitted from the cell station cannot reflect the frequency resource allocation status and an effect of the transmission beam, with respect to the interference of a data signal between cells; the data signal being transmitted by way of a shared channel. Then, as a method for allocating the frequency resources in consideration of the interference between cells, known is a method including a correction of a channel quality measured by using a reference signal, while the frequency resource allocation status at each cell being notified each other between the cells.

Unfortunately, hereby it is impossible to reflect an actual amount of interference, such as an effect of a transmission beam & a receiving beam, and the like, by way of simply correcting the channel quality while the frequency resource allocation status being notified each other between the cells. Therefore, an outer loop process for correcting the channel quality, with reference to a data transmission error ratio, is carried out. For the outer loop process, a process of calculating an offset value is generally used according to a formula described below; the offset value being for adding a decibel value to the channel quality.

$$\begin{matrix}\{ Formula 1 \} & \\ CQI\_offset ( n ) = \{ \begin{matrix}CQI\_offset ( n ) + {Δ}_{adj} ( n ) \times {BLER}_{target} ( n ) & if '' ACK '' \\ CQI\_offset ( n ) - {Δ}_{adj} ( n ) \times ( 1 - {BLER}_{target} ( n ) ) & if '' NACK '' \\ CQI\_offset ( n ) & otherwise\end{matrix} & ( 1 )\end{matrix}$$

wherein, ‘n’ represents an ID number of a mobile station; ‘CQI_offset’ represents an offset value of the channel quality, being expressed as a decibel value; ‘Δadj’ represents an update value of the offset value, being expressed as a decibel value; and ‘BLERtarget’ represents a target value of a block error ratio. According to the formula (1) described above; for each unit transmission data of a down-link, the offset value increases by ‘Δadj times BLERtarget’ in the case of communication succeeded, and in the meantime, the offset value decreases by ‘Δadj times (1−BLERtarget)’ in the case of communication failed. In the case where no communication is carried out, the offset value remains as it is.

As a frequency resource allocation method at a time of executing a multiple-user communication in the OFDMA system, there exists a method described in a prior art document named below. In PTL 1, it is described that radio resources are dynamically allocated in the case where a size of data to be transmitted is equal to or greater than a threshold value, and meanwhile the radio resources are allocated at constant intervals in the case where the size of data to be transmitted is less than the threshold value; and then at the time of dynamically allocating, the radio resources secured by the allocation at the constant intervals are allocated. In the meantime, it is described in PTL 2 that a cell station creates an interference information table on the basis of quality information of an up-link channel, and notifies a mobile station of the interference information table, and then the mobile station determines a frequency range of a pilot signal (i.e., the reference signal described above) and requires a transmission resource of the cell station. Moreover, in PTL 3, it is described that channel status information is created in a terminal device by using an offset value received from a cell station, with respect to each of a plurality of resource areas, or each of transmission frequencies of the channel status information.

### CITATION LIST

### Patent Literature

{PTL 1} JP 5069740 B

{PTL 2} WO 2008/093621

{PTL 3} JP 2012-533960 A

### SUMMARY OF INVENTION

### Technical Problem

ACK/NACK information to be used in an outer loop process is transmitted with respect to a unit communication channel, not with respect to each frequency channel. Namely, in the case where a plurality of frequency resources constitute one communication channel, the ACK/NACK information is transmitted as a communication result for an entire part of those plurality of frequency resources. Therefore, even if only one part of the frequency resources has interference, the other part of the frequency resources is also judged to be poor in quality, because of an influence of the one part of the frequency resources having the interference.

It is an objective of the present invention to solve the issue described above, so as to provide a frequency resource allocation method and a cell station with which it is possible to at least reduce an influence caused by a deteriorated quality of one part of frequency resources, acting on a frequency resource allocation with respect to the other part of frequency resources.

### Solution to Problem

According to a first aspect of the present invention, provided is a frequency resource allocation method of a cell station executing Orthogonal Frequency-Division Multiple Access communication to allocate a frequency resource to a down link to each mobile station, the frequency resource allocation method comprising: a step of receiving channel quality information of each frequency resource, and a validity judgment result on whether or not an entire part of frequency resources allocated to the mobile station has correctly received data, from each mobile station; a step of calculating an allocation index for allocating frequency resources for each mobile station, on the basis of the channel quality information and the validity judgment result received from the mobile station; and a step of allocating a frequency resource to each mobile station on the basis of the allocation index; wherein, in the step of calculating an allocation index, a correction value on the basis of the validity judgment result is calculated for each group of frequency resources, therein the frequency resources being allocated to the mobile station and being divided into a plurality of groups; and the allocation index is calculated according to the correction value for each group and the channel quality information.

According to a second aspect of the present invention, provided is a cell station for executing Orthogonal Frequency-Division Multiple Access communication between a mobile station and the cell station itself, the cell station comprising: a means for receiving channel quality information of each frequency resource, and a validity judgment result on whether or not an entire part of frequency resources allocated to the mobile station has correctly received data, from each mobile station; a means for calculating an allocation index for each mobile station, for allocating frequency resources to the mobile station, on the basis of the channel quality information and the validity judgment result received from the mobile station; and a means for allocating a frequency resource to each mobile station on the basis of the allocation index; wherein the means for calculating an allocation index includes a means for calculating a correction value on the basis of the validity judgment result, for each group of frequency resources, therein the frequency resources being allocated to the mobile station and being divided into a plurality of groups; and a means for calculating the allocation index according to the correction value for each group and the channel quality information.

### Advantageous Effects of Invention

The present invention provides an effect for at least reducing an influence caused by a deteriorated quality of one part of frequency resources, acting on a frequency resource allocation with respect to the other part of frequency resources.

### BRIEF DESCRIPTION OF DRAWINGS

FIG. 1 is a block configuration diagram for explaining a radio communication system that substantializes the present invention.

FIG. 2 is a diagram for explaining interference between cells.

FIG. 3 is a diagram showing an example of an allocation index of frequency resources.

FIG. 4 is a diagram showing an example of a frequency resource allocation.

FIG. 5 is a block diagram showing a circuit configuration for calculating an allocation index (background art).

FIG. 6 is a diagram showing a correction example on an allocation index according to the background art shown in FIG. 5.

FIG. 7 is another diagram showing a correction example on an allocation index according to the background art shown in FIG. 5.

FIG. 8 is a block diagram showing a configuration example of an allocation index calculator (according to an embodiment of the present invention) shown in FIG. 1.

FIG. 9 is a diagram showing a process flow of a frequency resource allocation method of the embodiment of the present invention.

FIG. 10 is a diagram showing a process of Step S12 in FIG. 9, for more details.

FIG. 11 is a diagram showing a correction example on an allocation index according to the embodiment of the present invention.

FIG. 12 is a diagram showing an example of a frequency allocation according to the embodiment of the present invention.

### DESCRIPTION OF EMBODIMENTS

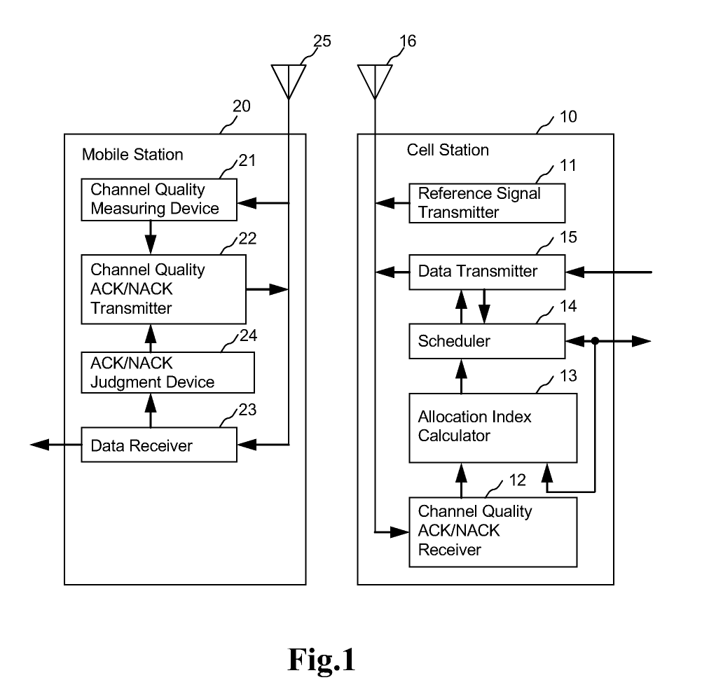

FIG. 1 is a block configuration diagram for explaining a radio communication system that embodies the present invention. In order to make a simple explanation in this case, there is illustrated only a configuration with regard to a down link.

The radio communication system includes a cell station 10 and a mobile station 20. As a configuration with regard to a down link, the cell station 10 includes a reference signal transmitter 11, a channel quality ACK/NACK receiver 12, an allocation index calculator 13, a scheduler 14, a data transmitter 15, and a transmit-receive antenna 16. Meanwhile, as a configuration with regard to a down link, the mobile station 20 includes a channel quality measuring device 21, a channel quality ACK/NACK transmitter 22, a data receiver 23, an ACK/NACK judgment device 24, and a transmit-receive antenna 25.

The reference signal transmitter 11 of the cell station 10 creates a reference signal and transmits the reference signal via the transmit-receive antenna 16. The scheduler 14 determines an allocation for each mobile station to a frequency resource. The data transmitter 15 allocates a datum for each mobile station to a frequency resource, according to the allocation by the scheduler 14, and then transmits the datum via the transmit-receive antenna 16.

In the mobile station 20, the channel quality measuring device 21 picks up the reference signal out of a signal received by the transmit-receive antenna 25 in order to measure a channel quality. The channel quality ACK/NACK transmitter 22 transmits the channel quality measured by the channel quality measuring device 21 via the transmit-receive antenna 25. The data receiver 23 receives a data signal out of the signal received by the transmit-receive antenna 25. The ACK/NACK judgment device 24 makes a judgment on ACK/NACK, according to whether the data receiver 23 has correctly received the data. The judgment result is transmitted, as ACK/NACK information, via the transmit-receive antenna 25 by the channel quality ACK/NACK transmitter 22.

The channel quality ACK/NACK receiver 12 of the cell station 10 detects channel quality information of each frequency resource, and ACK/NACK information that is a validity judgment result on whether or not an entire part of frequency resources allocated to the mobile station has correctly received data, from each mobile station, out of a signal received by the transmit-receive antenna 16. For each mobile station, the allocation index calculator 13 calculates an allocation index for allocating frequency resources to the mobile station, in accordance with the channel quality information and the ACK/NACK information received from the mobile station. In this calculation, the allocation index calculator 13 calculates a correction value on the basis of the validity judgment result, for each group of frequency resources, wherein the frequency resources being allocated to the mobile station and being divided into a plurality of groups; and then calculates an allocation index, according to the correction value for each group and the channel quality information. The scheduler 14 determines an allocation of transmission data for each mobile station to a frequency resource, on the basis of the allocation index obtained by way of the calculation of the allocation index calculator 13.

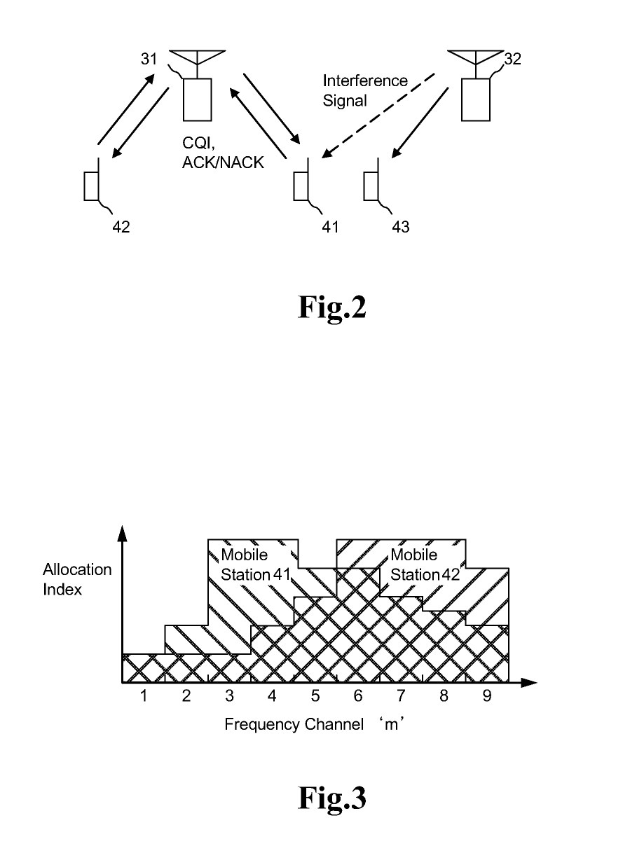

FIG. 2 is a diagram for explaining interference between cells. In this case, shown is a connection example including cell stations and mobile stations, in which there exist two cell stations (cell stations 31 and 32) and three mobile stations (mobile stations 41, 42, and 43). On an assumption, the mobile stations 41 and 42 are connected to the cell station 31, and meanwhile the mobile station 43 is connected to the cell station 32. At a time when the mobile station 41 comes close to a cell of the cell station 32 under the connecting situation, a transmission from the cell station 32 to the mobile station 43 potentially causes interference at the mobile station 41.

FIG. 3 is a diagram showing an example of an allocation index of frequency resources in an example of FIG. 2. In the example, frequency resources are expressed as nine frequency channels. A right-down diagonal-lined section represents an allocation index with respect to the mobile station 41, and meanwhile a right-up diagonal-lined section represents an allocation index with respect to the mobile station 42. At each frequency channel, the frequency channel is allocated to a mobile station having an allocation index of a high value. {0020}

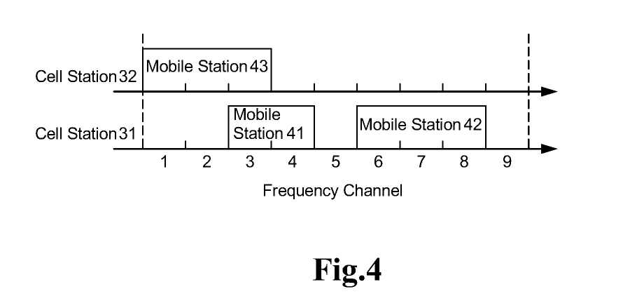

FIG. 4 shows an example of a frequency resource allocation in the example of FIG. 2. In the example, the cell station 31 allocates frequency channels #3 and #4 to the mobile station 41, and allocates frequency channels #6 through #8 to the mobile station 42. Frequency channels not yet allocated may be allocated to the mobile stations 41 and 42, or may be allocated to another mobile station under control of the cell station 31. The cell station 32 allocates frequency channels #1 through #3 to the mobile station 43.

In the example of FIG. 4, the frequency channel #3 is allocated to the mobile station 41 in the cell station 31, and meanwhile it is allocated to the mobile station 43 in the cell station 32. As shown in FIG. 2, depending on positional relationships of the cell stations 31 and 32 as well as the mobile stations 41 and 43, and also directions of a transmission beam & a receiving beam of the cell stations 31 and 32 as well as the mobile stations 41 and 43, a transmission of the frequency channel #3 from the cell station 32 to the mobile station 43 can potentially cause interference with a transmission of the frequency channel #3 from the cell station 31 to the mobile station 41. If once the interference is caused, a receiving quality of the frequency channel #3 at the mobile station 41 gets deteriorated more than a quality corresponding to the allocation index in FIG. 3. In the meantime, the ACK/NACK information is transmitted with respect to a unit communication channel, not with respect to each frequency channel, in a method such as LTE (Long Term Evolution) of 3GPP (Third Generation Partnership Project). Therefore, in the case where the frequency channel #3 and the frequency channel #4 constitute one communication channel, the ACK/NACK information is transmitted as a total communication result for the frequency channels #3 and #4. Accordingly, even if only the frequency channel #3 has interference, both the frequency channel #3 and the frequency channel #4 are poor in quality, at the mobile station 41, because of an influence of the frequency channel #3 having the interference.

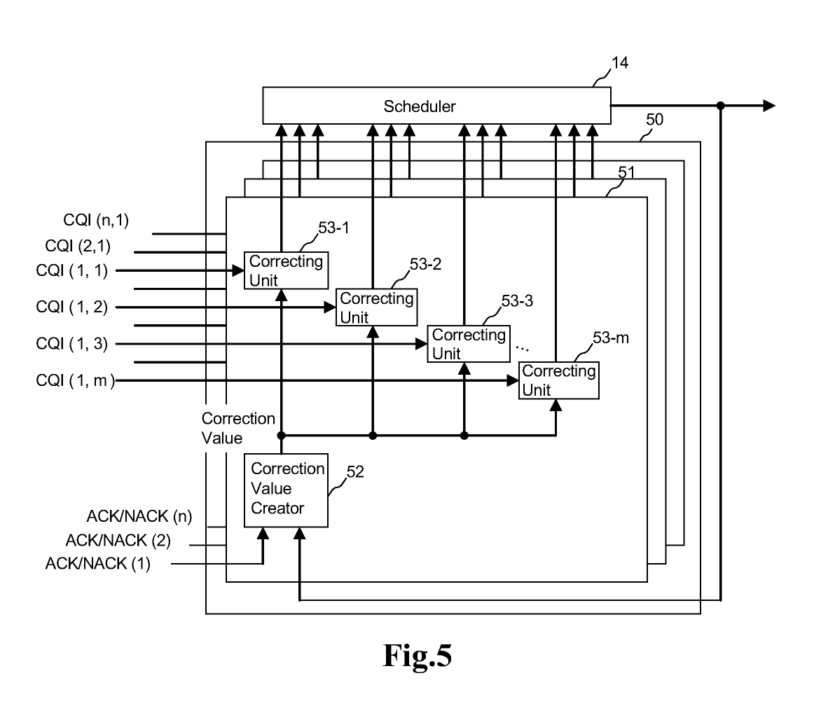

FIG. 5 is a block diagram showing a circuit configuration for calculating an allocation index. An allocation index calculator 50 shown in FIG. 5 calculates a correction value of an allocation index by way of the outer loop process indicated with formula (1), and the allocation index calculator 50 is based on a background art for the allocation index calculator 13 shown in FIG. 1.

ACK/NACK information, ACK/NACK(n) (n=1, 2, - - - , N) and Channel Quality Information CQI(n, m) (m=n=1, 2, - - - , M) for each frequency channel are entered from each mobile station into the allocation index calculator 50.

The allocation index calculator 50 has a correction processor 51 for each mobile station. Each correction processor 51 is provided with a correction value creator 52 and correcting units, 53-1 through 53-m, for each frequency channel, which are allocated to a mobile station. The correction value creator 52 creates a correction value by use of the formula (1), in response to the ACK/NACK information, and information on presence of a frequency channel allocation notified from the scheduler 14. The correcting units, 53-1 through 53-m, individually calculate an allocation index for each frequency channel, on the basis of the Channel Quality Information CQI(n, m); and also correct the allocation index, according to the correction value calculated by the correction value creator 52. The scheduler 14 determines an allocation for each frequency channel to each mobile station, in response to the allocation index for each frequency channel of each mobile station.

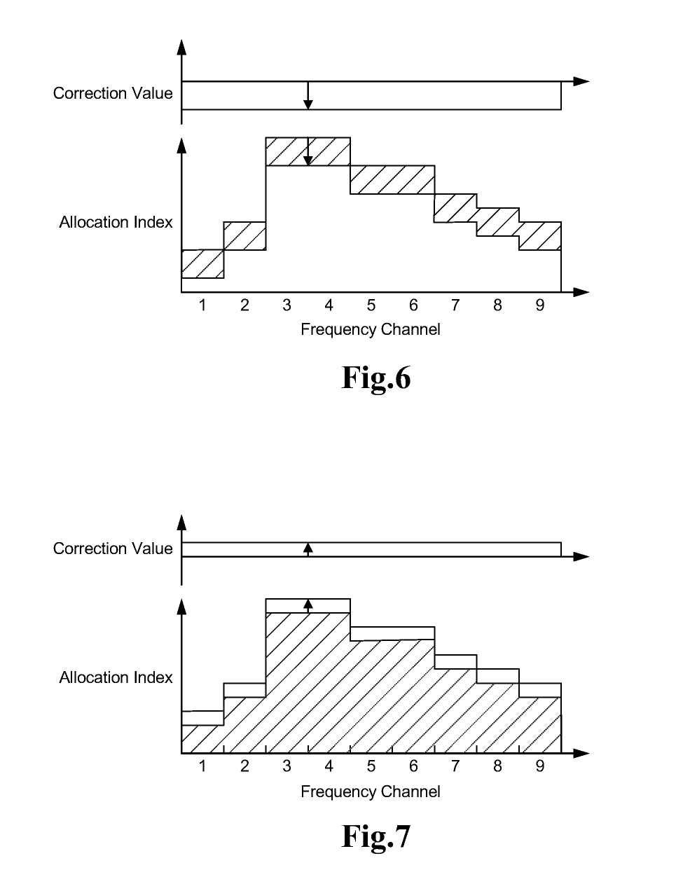

FIG. 6 and FIG. 7 individually show a correction example on an allocation index according to the background art shown in FIG. 5.

In the background art shown in FIG. 5, there exists one correction value creator 52, and accordingly one offset value is provided to each mobile station. By way of the outer loop process, the allocation index is uniformly corrected with respect to all frequency channels; namely, so as to make the allocation index smaller in the example of FIG. 6, and so as to make the allocation index greater in the example of FIG. 7. In other words, frequency characteristics do not change in the allocation index for each mobile station, in the correction by way of the outer loop process. A correction on an allocation index of a frequency channel cannot reflect interference between cells, unless frequency characteristics change in the correction. Since the ACK/NACK information does not reflect quality of all the frequency channels as described above, the correction value should not uniformly be applied to all the frequency channels, and therefore the correction value should be reflected only to a frequency channel that the ACK/NACK information represents.

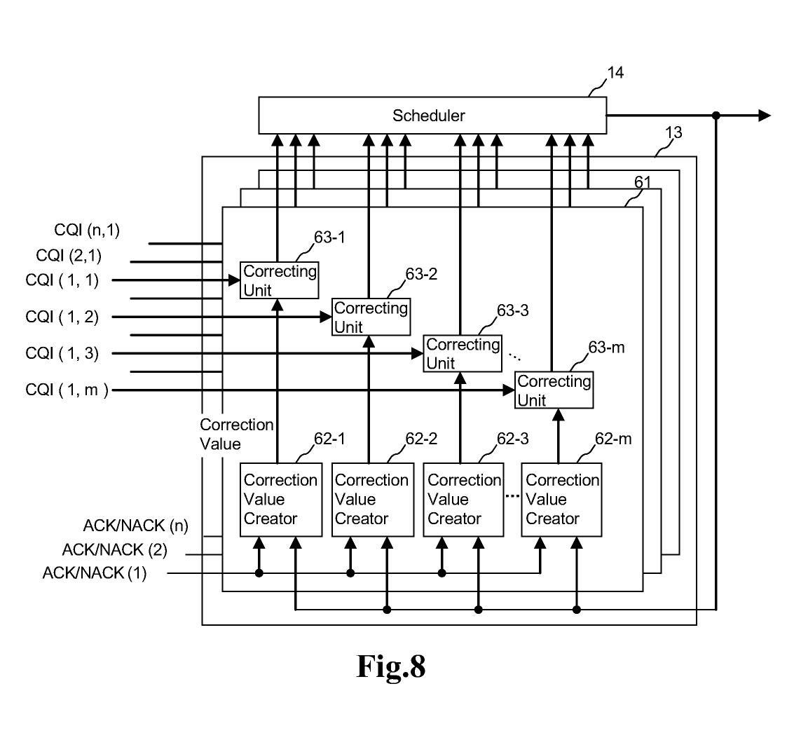

FIG. 8 is a block diagram showing a configuration example of the allocation index calculator 13 shown in FIG. 1. In this case, an explanation is made on an assumption that a frequency resource is allocated to each frequency channel, and a correction value is calculated for each frequency channel.

In the allocation index calculator 13 shown in FIG. 8, a circuit corresponding to the correction value creator 52, in the background art shown in FIG. 5, is provided to each frequency channel. In other words, the allocation index calculator 13 is provided with each correction processor 61 for each mobile station. Meanwhile, each correction processor 61 includes correction value creators 62-1 through 62-m for calculating a correction value based on the ACK/NACK information, for each of ‘m’ frequency channels that are individually allocated to a corresponding mobile station; and correcting units 63-1 through 63-m for calculating an allocation index on the basis of the correction value for each frequency channel and the Channel Quality Information.

The correction value creators 62-1 through 62-m update a correction value (an offset value) of the outer loop process, according to an allocation result for a frequency channel notified from the scheduler 14, and according to the ACK/NACK information with respect to the frequency channel for which an allocation has been made. The correcting units 63-1 through 63-m calculate an allocation index for each frequency channel by use of the Channel Quality Information CQI(n, m), and also correct the allocation index by use of the correction value calculated by the correction value creators 62-1 through 62-m. An updating process by the correction value creators 62-1 through 62-m is expressed as a formula described below:

$$\begin{matrix}\{ Formula 2 \} & \\ CQI\_offset ( n , m ) = \{ \begin{matrix}\begin{matrix}CQI\_offset ( n , m ) + \\ {Δ}_{adj}^{n} \times {BLER}_{target}^{n}\end{matrix} & if assign RB ( m ) and '' ACK '' \\ \begin{matrix}CQI\_offset ( n , m ) - \\ {Δ}_{adj}^{n} \times ( 1 - {BLER}_{target} )\end{matrix} & if assign RB ( m ) and '' NACK '' \\ CQI\_offset ( n , m ) & otherwise\end{matrix} & ( 2 )\end{matrix}$$

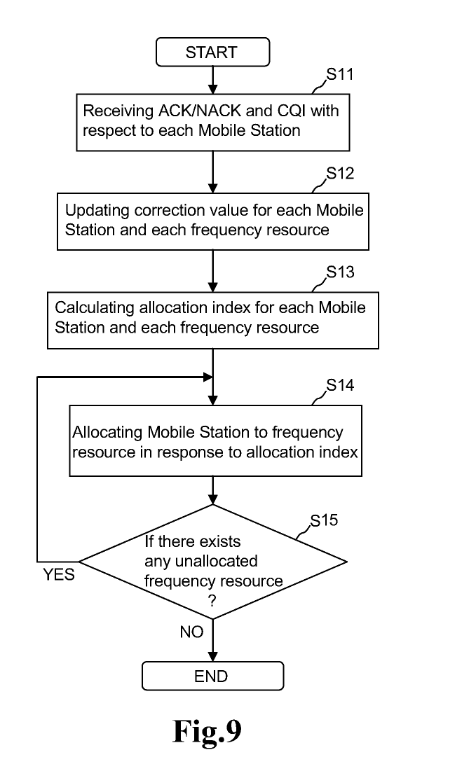

FIG. 9 shows a process flow of a frequency resource allocation method of the embodiment of the present invention shown in FIG. 1 and FIG. 8.

At first, the channel quality ACK/NACK receiver 12 receives the ACK/NACK information, ACK/NACK(n) (n=1, 2, - - - , N) and the Channel Quality Information CQI(n, m) (n=1, 2, - - - , N; m=n=1, 2, - - - , M) of each frequency channel, with respect to each mobile station (Step S11). Although the drawing describes a procedure to be done for ‘EACH FREQUENCY RESOURCE,’ the ‘FREQUENCY RESOURCE’ may be set up in the same size as the frequency channel, and may also be set up by grouping several frequency channels.

Next, the correction value creators 62-1 through 62-m in the allocation index calculator 13 update a correction value CQI_offset(n, m) for each mobile station and each frequency channel (Step S12). This updating process is carried out by means of the formula (2), according to whether a frequency channel ‘m’ is allocated to a mobile station ‘n’, and also in response to the ACK/NACK information, ACK/NACK(n).

The correcting units 63-1 through 63-m in the allocation index calculator 13 calculate an allocation index individually for each mobile station and each frequency channel, on the basis of the Channel Quality Information CQI(n, m); and correct the allocation index (Step S13) by use of the correction value CQI_offset(n, m) calculated at Step S12.

The scheduler 14 allocates a frequency channel to a mobile station (Step S14), in response to the allocation index calculated at Step S13. The scheduler 14 also checks whether or not there exists any unallocated frequency channel (Step S15); and returns to Step S14 if there exists an unallocated frequency channel, and meanwhile quits the allocation process if there exists no unallocated frequency channel.

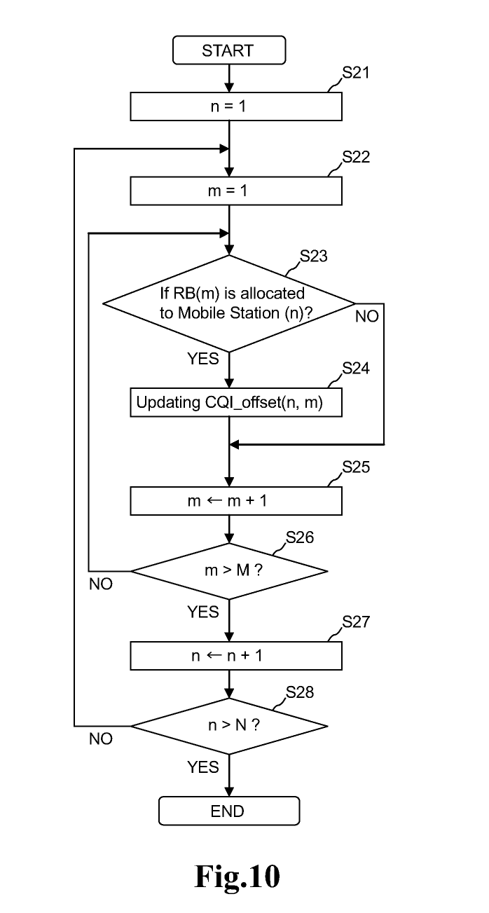

FIG. 10 is a diagram showing a process of Step S12 in FIG. 9, for more details. In the allocation index calculator 13 shown in FIG. 8, the correction value creators 62-1 through 62-m are provided for each mobile station and each frequency channel. With respect to this configuration, operation of these correction value creators 62-1 through 62-m can also be implemented by way of a sequential process, as shown in FIG. 10.

In this process, at first, an ID number ‘n’ of a mobile station to be handled is set with an initial vale ‘1’ (Step S21), and an ID number ‘m’ of a frequency channel to be handled is set with an initial vale ‘1’ (Step S22). Then, it is judged whether a frequency channel RB(m) is allocated to the mobile station (n) (Step S23). If the frequency channel RB(m) is allocated (YES at Step S23), the correction value CQI_offset(n, m) is updated in accordance with the formula (2) (Step S24). In the case of NO at Step S23, Step S24 is skipped. Next, the ID number ‘m’ of a frequency channel is incremented by ‘1’ (Step S25), and then it is judged whether all frequency channels are already handled (Step S26). If there still exists any frequency channel that is not yet updated (NO at Step S26), operation returns to Step S23. If the updating process has already finished for all the frequency channels (YES at Step S26), the ID number ‘n’ of a mobile station is incremented by ‘1’ (Step S27), and then it is judged whether all mobile stations are already handled (Step S28). If there still exists any mobile station that is not yet handled (NO at Step S28), operation returns to Step S22. In the meantime, if all the mobile stations have already been handled (YES at Step S28), operation finishes.

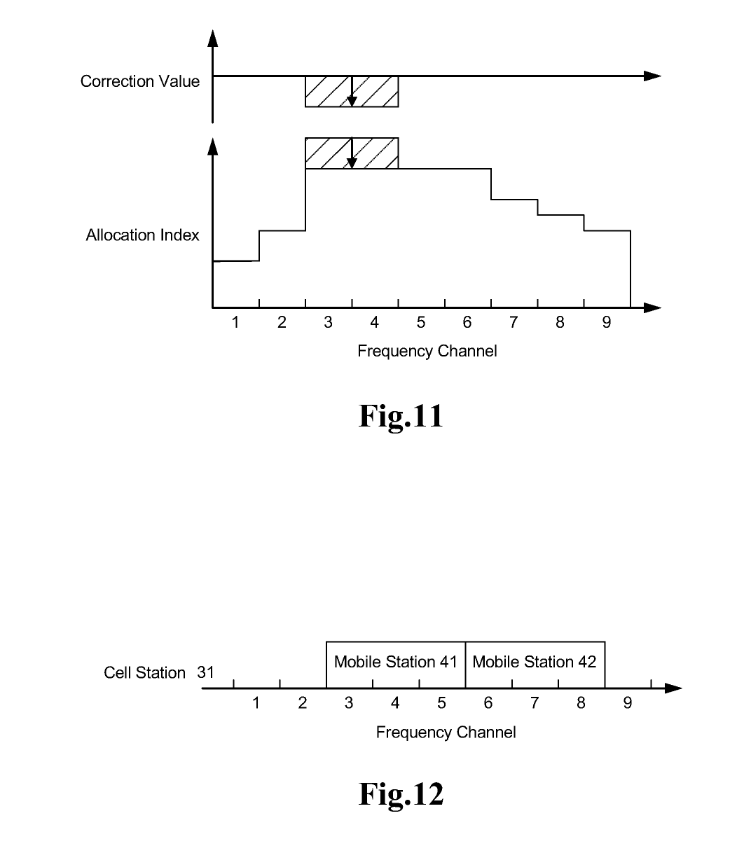

FIG. 11 shows a correction example on an allocation index according to the embodiment of the present invention.

It is assumed that, as shown in FIG. 4, the frequency channels #3 and #4 are allocated to the mobile station 41 at the cell station 31; and meanwhile, the frequency channels #3 is allocated to the mobile station 43, which is another mobile station, at the cell station 32. Under the situation, a receiving quality of the frequency channel #3 gets deteriorated at the mobile station 41, so that a data communication quality gets lowered in a down link for the frequency channel #3 together with the frequency channel #4. As a result, according to the background art shown in FIG. 5, the correction value of the mobile station 41 uniformly gets lowered across a entire range of all the frequency channels, as shown in FIG. 6.

On the other hand, according to the embodiment of the present invention shown in FIG. 1 and FIG. 8, the correction value gets lowered with respect to only a part of the frequency channels #3 and #4 that are allocated to the mobile station 41 as shown in FIG. 11. Although the allocation index after the correction by means of the background art shown in FIG. 5 is as a section without diagonal lines shows in FIG. 6, the allocation index after the correction according to the embodiment shown in FIG. 1 and FIG. 8 becomes as a section without diagonal lines shows in FIG. 11.

FIG. 12 shows an example of a frequency allocation according to the embodiment of the present invention.

According to the background art shown in FIG. 5, frequency characteristics of an allocation index do not change, and therefore frequency channels allocated to the mobile station 11 are the frequency channels #3 and #4, as they are. On the other hand, according to the embodiment of the present invention, the frequency characteristics of an allocation index do change so that, in an example shown in FIG. 11, the frequency channels #5 and #6 also come up as candidates to be allocated to the mobile station 41. FIG. 12 shows an example in which the frequency channel #5 is actually allocated to the mobile station 41. While a frequency channel, being different from what the background art allocates, comes up as a candidate for allocation in this way, there appears a possibility that a frequency channel having less interference between cells is selected, so that there comes up a chance that an average quality of frequency channels allocated to a mobile station is upgraded.

In the above explanation, there is discussed by using an example in which frequency resources are allocated to each frequency channel, and a correction value is calculated for each frequency channel. It is not limited that frequency resources are allocated to each frequency channel, and the frequency resources can be allocated to a unit including a plurality of frequency channels. Furthermore, a unit group, for which a correction value is calculated, may be different from a unit group of frequency resources (frequency channels), for which Channel Quality Information is notified. In other words, a correction value may be calculated with respect to each of a plurality of groups, into which frequency resources allocated to a mobile station are divided; for example, each group including a plurality of frequency channels together.

Instead of using a CQI value as it is; as an allocation index for a frequency channel, it is possible to use proportional fairness and the like that uses a value of CQI divided by an average throughput of each mobile station. The present invention can be applied, regardless of a type of an index.

### REFERENCE SIGNS LIST

10. cell station
11. reference signal transmitter
12. channel quality ACK/NACK receiver
13. allocation index calculator
14. scheduler
15. data transmitter
16. transmit-receive antenna
20. mobile station
21. channel quality measuring device
22. channel quality ACK/NACK transmitter
23. data receiver
24. ACK/NACK judgment device
25. transmit-receive antenna
61. correction processor
62-1 through 62-m. correction value creators
63-1 through 63-m. correcting units

1. A frequency resource allocation method of a cell station executing Orthogonal Frequency-Division Multiple Access communication to allocate a frequency resource to a down link to each mobile station, the frequency resource allocation method comprising:
a step of receiving channel quality information of each frequency resource, and a validity judgment result on whether or not an entire part of frequency resources allocated to the mobile station has correctly received data, from each mobile station;
a step of calculating an allocation index for allocating frequency resources for each mobile station, on the basis of the channel quality information and the validity judgment result received from the mobile station; and
a step of allocating a frequency resource to each mobile station on the basis of the allocation index;
wherein, in the step of calculating an allocation index, a correction value on the basis of the validity judgment result is calculated for each group of frequency resources, therein the frequency resources being allocated to the mobile station and being divided into a plurality of groups; and the allocation index is calculated according to the correction value for each group and the channel quality information.

2. The frequency resource allocation method according to claim 1;
wherein the correction value is updated on the basis of the judgment result, with respect to a group of frequency resources allocated in previous communication.

3. The frequency resource allocation method according to claim 1;
wherein one group is set up for each frequency resource, and the correction value is created for each frequency resource.

4. The frequency resource allocation method according to claim 4;
wherein the frequency resource is allocated in the same size as the frequency channel, or allocated by grouping several frequency channels as a unit.

5. A cell station for executing Orthogonal Frequency-Division Multiple Access communication between a mobile station and the cell station itself, the cell station comprising:
a means for receiving channel quality information of each frequency resource, and a validity judgment result on whether or not an entire part of frequency resources allocated to the mobile station has correctly received data, from each mobile station;
a means for calculating an allocation index for each mobile station, for allocating frequency resources to the mobile station, on the basis of the channel quality information and the validity judgment result received from the mobile station; and
a means for allocating a frequency resource to each mobile station on the basis of the allocation index;
wherein the means for calculating an allocation index includes a means for calculating a correction value on the basis of the validity judgment result, for each group of frequency resources, therein the frequency resources being allocated to the mobile station and being divided into a plurality of groups; and a means for calculating the allocation index according to the correction value for each group and the channel quality information.
